(19) United States
(12) Patent Application Publication
(10) Pub. No.: US 2015/0052468 A1
(43) Pub. Date: Feb. 19, 2015

(54) HIGH DYNAMIC RANGE PARAMETER ADJUSTMENT IN A GRAPHICAL USER INTERFACE USING GRAPHICAL MOVING SCALES

(71) Applicant: Peter Adany, Kansas City, MO (US)

(72) Inventor: Peter Adany, Kansas City, MO (US)

(21) Appl. No.: 13/966,567

(22) Filed: Aug. 14, 2013

(51) Int. Cl. G06F 3/0484; G06F 3/0481

(52) U.S. Cl. CPC G06F 3/04847; G06F 3/0481
USPC 715/771

(57) ABSTRACT

The invention includes methods and graphical interfaces to provide high dynamic range parameter adjustment in a graphical user interface by combination of a moving dial and moving scales in a single visual group. The motion of moving scales is opposite in direction to the motion of a dial moving in a direction defined by user input. Moving scales are translated by different amounts per amount of parameter value change to visually convey different magnitudes of change. The single dial indicates value in all of the scales, and the total value can be read to the precision of the most minor scale over a range of values of the most major scale by combined visual assessment of the multiple scales. The methods for graphical representation of values by a graphical scale group, and the governing rules for motion of the scales, are described. In view of the role of visual representation as a feedback signal to the user during adjustment of a parameter, the invention overcomes limitations of traditional graphical controllers that use a single moving graphical component with a linear mapping of the range of parameter values to the range of displacement of the component in the display, and which are thus restricted by the physical size and pixel count of the display. The purpose of the invention is to provide visual indication of parameter value adjustment with high dynamic range in graphical interfaces by the use of graphical moving scales.

### RELATED APPLICATIONS

This application is based upon, and claims priority to, previously filed provisional application Ser. No. 61/683122, filed on Aug. 14, 2012. The provisional application is hereby incorporated by reference.

### BACKGROUND

The design of graphical controllers originates from physical counterparts such as sliding and rotating mechanical devices. In graphical user interfaces, the concept of adjustment by physical motion offers an intuitive method of parameter adjustment and involves the translation of user input, achieved through various means by the device, into visual changes on the device display. Graphically displayed controllers most often use proportional translation of a single graphical component to indicate the change of value. Proportional translation comprises positioning of graphical elements with a linear mapping of the total range of parameter values to the total range of displacements of the graphical component on a display. In the parameter adjustment process, visual representation serves as a feedback signal to the user. Because of the user's reliance on visual feedback in the adjustment process, the user can adjust the parameter only with a finite resolution, that resolution being no less than the smallest increment of value that results in visible change. The dynamic range of parameter adjustment is defined as the ratio of the largest possible visually represented change of value to the smallest possible visually represented change of value. The pixel density and physical size of displays constrain the visual representation of motion to a relatively small range. Therefore, when using the traditional method of proportional translation of a single graphical component, the dynamic range of parameter adjustment is limited by the pixel count and physical size of displays.

### BRIEF DESCRIPTION OF THE DRAWINGS

FIG. 1 shows graphical components used for high dynamic range parameter adjustment according to the methods disclosed.

FIG. 2 shows an application example of the methods disclosed, providing the high dynamic range parameter adjustment of a linear-path sliding controller.

FIGS. 3A and 3B identify markings of equal values on adjacent scales as well as the relative displacements of the dial and moving scales after adjustment, along with details indicating major and minor markings, respectively.

FIG. 4 shows enlarged detail of the dial and scales, with arrows showing position changes between the dial, master scale, first moving scale and second moving scale.

### DETAILED DESCRIPTION

To solve the problem of limited dynamic range of parameter adjustment by visual proportional translation of graphical controllers in graphical displays, new methods and graphical interfaces for display of the absolute value and changes of value of a parameter for computer devices, touch-screen devices, and other user interfaces are disclosed.

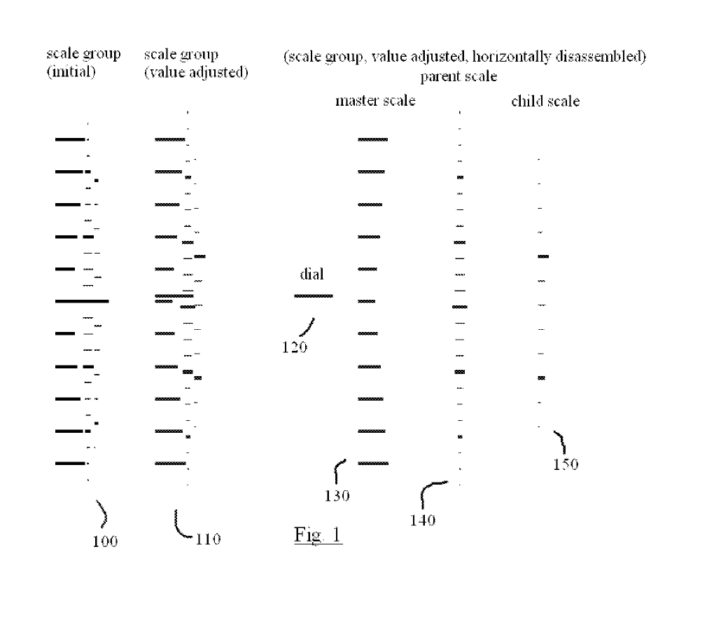

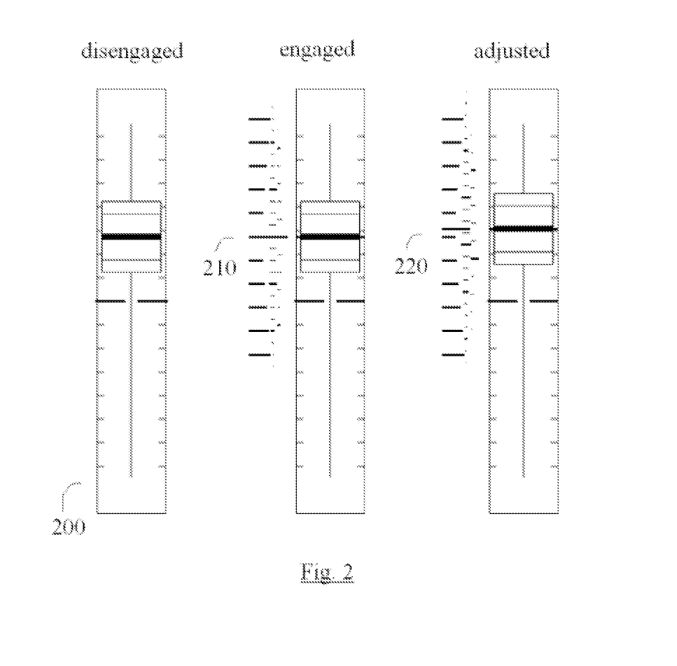

Devices with graphical interfaces may accept, by any means of input, the change of a parameter value under user control. The methods and graphical interfaces disclosed are applicable to any display technology, including touch-screens, and they are applicable to the following graphical controller representations: sliding controllers, rotary controllers, non-moving controller shapes, and regions designated within a display for providing visual feedback during user input. The present invention requires the graphical displaying of a dial and multiple scales according to the methods disclosed. The necessary graphical interfaces are shown in FIG. 1, which shows graphics in an initial state 100, and adjusted state 110. Specifically, shown in FIG. 1, the graphical interfaces of a dial 120, and moving scales, specifically 140, are required for the operation of the present invention. Additional application is provided by inclusion of a master scale 130 and additional scales following the model of the second scale 150. As an example of one of the applicable graphical interface control types as shown in FIG. 2, a linear-path sliding controller 200 can be used, with example placement of initial graphics 210 and example adjusted-value graphics 220 shown placed adjacent to the controller 200.

The dynamic range of parameter adjustment is defined as the ratio of the largest possible visually represented change of value to the smallest possible visually represented change of value. Visual representation serves as a feedback signal to the user during parameter adjustment. Adjustment is made by changes of the parameter value in finite increments, while observing changes on a display. Because of the necessity of visual feedback in the adjustment process, the user can adjust the parameter only with a finite resolution, that resolution being no less than the smallest increment of value that results in visible change.

In this document, the term Translation refers to the change of position, change of rotation, or any combination thereof, of graphical components, and the term Proportional refers to a linear mapping of the total range of parameter values to the total range of displacements of the graphical component on a display. Graphical representation of value by a controller has previously relied on proportional translation of a single graphical component. The pixel density and physical size of displays constrain the visual representation of motion to a relatively small range. With proportional translation of a single graphical component, very small changes of value cannot be visually represented because the change of value relative to its total range can be orders of magnitude smaller than the range of motion of the graphical components. Therefore, when using the method of linear mapping of a single graphical component, the dynamic range of parameter adjustment is limited by the pixel count and physical size of displays.

In computer devices, touch-screen devices, and other user interfaces, user input can be mathematically transformed into adjustments too small to be visually represented by proportional translation. Such a transformation is realized by nonlinear mathematical functions. In the methods disclosed, user input can be mathematically transformed into small adjustments through evaluation of a nonlinear response function, and multiple moving graphical components are utilized so that any desired amount of change can result in visible position change of at least one graphical element.

In order to provide a visual reference of the adjustment of the value, graphical scales, shown in FIG. 1, are displayed in the vicinity of a position in the display. A graphical scale is made by a group of line segments equidistant to each other by a predetermined distance.

User engagement of parameter adjustment occurs in continuous time periods. In the preferred embodiment, a master scale is displayed so that its position remains static at a local position during a continuous period of user engagement, and can therefore be called quasi-static. There are multiple configurations for the choice of the quasi-static local position of the master scale. In a first configuration, the position of the master scale is always at one reference position, for example the reference position can be a designated coordinate within a display, or it can be the position nearby an associated graphical controller, for example the reference position can be the midway point of an associated graphical component such as a sliding controller. A sliding controller is shown in FIG. 2. In a second configuration, at the start of user engagement the master scale is positioned with its center mark at an initial starting position that can be different for each period of user engagement, for example the reference position upon each period of user interaction can be the initial position of the moving component of the graphical controller. In a third configuration, the local position can be determined arbitrarily, for example the local position can set nearest to the user input on a touch-screen or pointer coordinates, such that the local position remains the same during the period of user interaction with the controller. The methods and graphical interfaces disclosed are inclusive of these three stated configurations.

One or more moving scales are displayed so as to be visually adjacent to the master scale. The positioning of moving scales in the present invention derives from the visual effect of a magnifying lens as follows: when moved in one direction over a surface, a magnifying lens gives an image that moves noticeably in the opposite direction relative to the frame of the magnifying glass by an amount determined by the relative sizes of the lens and the area imaged underneath. This is paralleled by the motion of scales whereby a scale with finer gradation moves more than one with a coarser gradation. In the preferred embodiment of the present invention, if an associated controller is displayed, then the motion of a moving scale is opposite in direction to the direction of motion of the displayed controller's moving component, and if an associated controller is not displayed, then the user input indicates a direction; for example, value increase is commonly associated with upward motion and value decrease is commonly associated with downward motion, and thus the motion of moving scales is opposite to that user indicated direction.

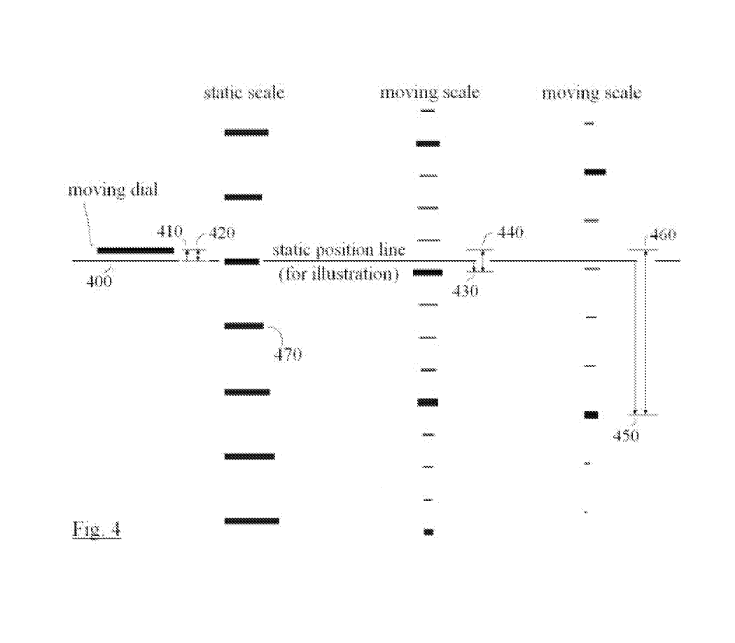

The positioning of graphical components is indicated in greater detail in FIG. 4. The static central position of the master scale is shown by a line detail 400 superimposed for illustration. At any time during user engagement the current value is indicated by the position of a single dial. The dial is a single line segment positioned relative to the scale graphical components. The dial simultaneously indicates the parameter value within the master scale and all moving scales, each scale contributing a different effective visual magnification of parameter change under view. In order for the dial to correctly indicate values inside moving scales even as the dial itself is moved, the positioning of moving scales must incorporate and compensate for the motion of the dial appropriately. The displacement of the dial, first and second scales relative to the static line 400, are shown by single ended arrows 410, 430 and 450, respectively, to positions marked by line details superimposed for illustration The relative displacement between the dial and the master scale, first scale and second scale are shown by double-ended arrows 420, 440 and 460, respectively. The displacements shown by 410 and 420 are identical because the master scale position remains static during engagement.

Shown in FIG. 1 are a dial 120, master scale 130, first moving scale 140, which is a parent scale, and a second moving scale 150, which is a child scale of 140. In FIG. 1, 100 shows a scale group prior to adjustment, and 110 shows a similar scale group with value slightly adjusted. An example of determination of the precise value using FIG. 4 can be given as follows: if the master scale markings such as 470 correspond to integers increments, with the master scale marking over line annotation 400 indicating the zero value, then the value depicted in FIG. 4 is 0.170±0.005.

It is shown by FIG. 1 or FIG. 4 that the master scale is not necessary for the complete representation of the parameter value, because the dial indicates the absolute value in each moving scale.

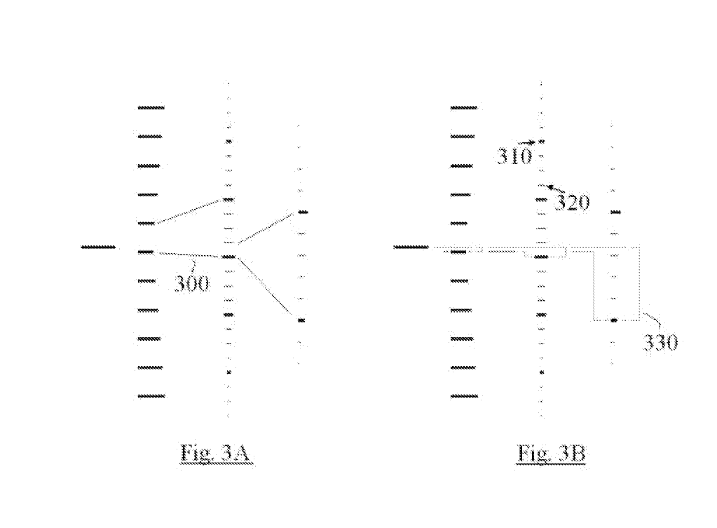

Scales with different magnification of relative position are displaced by different amounts, as shown in FIG. 3B. A parent scale is displaced by smaller amount than a child scale shown adjacent to it as shown by line brackets 330. The motions of the moving scales are always in the same direction with respect to each other, with the direction being determined by the user input as previously described. The ascendancy of scales can be in any direction, for example from left to right or right to left, or any combination thereof.

In order to graphically present moving scales within a constrained area, beginning and end markings of scales come into view or out of view by adding or removing end-most markings of a scale, or by adjusting the appearance of the scale towards its extents including modification of size, color, opacity, or any combination thereof. The central position, or locus, of moving scales generally changes during user adjustment. The display extents of moving scales are therefore restricted to some bounds around the vicinity of the dial. As scales are moved, farthermost markings are added, removed or visually modified to enforce visibility of only the markings that fall within the specified bounds around the dial. For example, in FIG. 3A the farthermost marking 340 is the first to disappear as the dial moves upward relative to the scales.

The spacing and sizing of scales are adjusted as a function of position relative to a visual locus, for example the position of the dial or the center of the master scale, to improve visual interpretation of value by the user. Peripheral vision plays a role in assessment of motion, while direct observation is required to read the exact value of the dial. Therefore, markings closer in distance to the visual locus are given greater visual impact than those farther away. To create this visual effect, the proximities of markings to the visual locus are emphasized by adjusting the size of the markings, or the color, opacity or brightness relative to the background, or any combination thereof.

All moving scales have major markings and a specified number of minor markings between the major markings. As shown in FIG. 3A by thin lines 300 superimposed for illustration, the major markings of a child scale represent the same values as one of the major or minor scales of an adjacent parent scale. When the dial is aligned with any major or minor marking of a parent scale and it is also exactly aligned with a major marking of the adjacent child scale, then the value of the parameter is equal to the value indicated by the parent scale marking.

Different magnitudes of change of value can be visually gauged by inspecting one of several adjacent scales. The different relative magnitude of displacements is indicated in FIG. 3B by the bracket lines 330 superimposed for illustration. High dynamic range of parameter control is achieved, because different scales move by different amount so as to visually convey change of various amounts to the user. In addition, the precise total value can be determined by reading position of the indicator dial across all the scales.

In the preferred embodiment, one master scale and two moving scales are used. A child scale can also be a parent scale to an additional scale, extendable to as many generations as necessary to achieve a desired dynamic range. Therefore, the present disclosure includes the possibility of displaying additional moving scales as necessary to achieve greater dynamic range.

Varied appearance is used to indicate the relationship of scale markings between parent and child scales. Color, opacity, size, graphical and textual labeling can be used to distinguish major and minor markings. A similarity of appearance, such as any combination of color, size, graphical and textual label, of any two markings on adjacent scales can be used to indicate that the two markings represent the same value. As shown in FIG. 3B, the major marking 310 is distinguished by larger size and darker value than the minor marking 320 of the same scale. In the example provided in FIG. 3B, minor marking 320 is placed at the one-fourth increment of the major marking 310. As another example, the rightmost scale in FIG. 3B has minor markings at multiples of one-fifth of the increment of its major markings. In the same example, the number of markings with which the dial can be aligned between successive markings of the parent scale is 20, the multiple of four and five.

The enlarged detail of graphical components is shown in FIG. 4. In order to accommodate the changing size and position of the moving scales, and to minimize the required display size, the widths of the master scale markings, such as marking 470, are dynamically adjusted. This reduces the required area for display while increasing visibility of the markings ranked by importance for the visual assessment of value.

Controlling the position of reactive moving objects by physical input is a customary visual motor-feedback process, and the illusion of motion plays an important role in the user's recognition. By the disclosed methods, the parameter value can be adjusted with high dynamic range of control, and total parameter value is readable at all times with a precision set by the number and dimension of multiple scales, and the presentation of moving scales is designed for improved visual recognition and to facilitate the user's ability to adjust a parameter value with high dynamic range.

What is claimed is:

1. A method for high dynamic range of adjustment of a parameter in a graphical user interface, comprising:
the display of a graphical scale group in graphical displays consisting of two principal graphical elements, those being an indicator dial and one or more moving scales;
the display of a number of moving scales, said number being determined by a minimum dynamic range of parameter value adjustment;
the positioning of moving scales in combination with a moving dial, each with various amounts of displacement, to represent a parameter value;
the movement of the single dial being in a direction the same as the user-indicated direction of input;
the movement of moving scales being in a direction opposite to the user-indicated direction of input;
the amount of displacement of any scale being governed so that its position relative to the moving dial is always such that the dial indicates the parameter value in the scale absolutely to the precision of said scale;
the absolute parameter values indicated by the markings of a scale being determined by the precision of parameter adjustment to be visually conveyed by said scale;
the amount of displacement of any scale being governed so that a subset of the total range of parameter values is spanned by the visible markings of said scale;
the parameter increments of the markings of multiple scales being determined so that the entire dynamic range of parameter adjustment from the smallest amount of change to the largest amount of change can be visually conveyed to the user at any time by at least one scale;
the positioning of the graphical scale group components so that the dial and one or more moving scale positions are updated so as to provide visual feedback of the parameter value during parameter adjustment by the user; and, the positioning of the graphical scale group components so that scales are visually proximal such that the absolute position of the dial via the ascendancy of the multiple scales can be assessed;
the positioning of a single dial among all of the scales so that the single dial indicates the parameter value simultaneously in every scale; and,
the movement of the moving scales being governed so that the product of distance traversed and relative parameter increment of scale markings is equal among all moving scales, as derived from the behavior of an image under a moving magnifying lens, whereby the motion of the dial can be compared to the motion of the lens, and the motion of moving scales can be compared to the motions of magnified images with different magnifications;

2. The method of claim 1 further comprising methods for graphic representation of parameter value by:
the placement of a graphical scale group without the display of a graphical controller, with arbitrary position of the scale group;
the placement of a graphical scale group at a position near an associated graphical controller, for example in the preferred embodiment the associated graphical controller is a linear-path sliding controller; and,
the positioning of the graphical scale group at a local position determined by any of three methods, those methods being: firstly, with reference to a displayed controller, at the beginning of a period of user engagement, a local position set so that a marking of the master scale is aligned with the position of the controller's moving component that indicates the current parameter value, or secondly, a local position set so that the center of the master scale is always at the same position, for example the position can be a designated position with the display or, with reference to a displayed controller, the position can be the midway point of travel of the controller's moving component, or, thirdly, a local position set to an arbitrary position at the start of user engagement, for example the point nearest to the user's input via touch-screen input or pointer coordinates.

3. The method of claim 1 further comprising user adjustment of a parameter value with high dynamic range of adjustment by:
the translation of user input by mathematical response calculations into parameter adjustment increments of a large range of magnitudes;
the movement of moving scales governed by mathematical rules so that at least one scale component is translated sufficiently upon parameter adjustment so as to visually convey an amount of change of value; and,
the relationship of positions of dial and moving scales being maintained during parameter adjustment by the user, or during inactivity of parameter adjustment, so that the parameter value indicated by the dial can be read at any time to the precision of the most minor scale in a range of values of the most major scale by combined visual assessment of the multiple scales.

4. The method of claim 1 further comprising graphical displays for visual interpretation of parameter value by:
the adjustment of scale marking appearance including size, color, opacity, graphical and textual labeling to distinguish major and minor markings of a scale;
the adjustment of scale marking appearance including size, color, opacity, graphical and textual labeling of major and minor markings to indicate value equivalences between adjacent scales;
the adjustment of scale marking appearance including size, color, opacity, graphical and textual labeling of the graphical scale components to visually emphasize the portions of components in proximity to the dial and to visually de-emphasize portions distant from the dial; and,
the adjustment of scale markings for the purpose of constraining the displayed area occupied by the graphical scale group to within specified bounds by the addition and removal of end markings of scales or the visual modification of scales at their extents including modification of size, color, opacity, or any combination thereof.
